(19) United States
(12) Patent Application Publication
(10) Pub. No.: US 2002/0005774 A1
(43) Pub. Date: Jan. 17, 2002

(54) RFID Tag For Authentication And Identification

(76) Inventors: Mr. Richard F. Rudolph, Loveland, OH (US); Mr. Rich Kirkham, Milford, OH (US)

Correspondence Address: Gibbons, Del Deo, Dolan, Griffinger & Vecchione, One Riverfront Plaza, Newark, NJ, 07102, US, 973-596-4500, 973-696-0545

(21) Appl. No.: 09/817,761

(22) Filed: Mar. 26, 2001

Related U.S. Application Data
(60) Provisional application No. 60/192,034, filed on Mar. 24, 2000.
(60) Provisional application No. 60/192,061, filed on Mar. 24, 2000.

(51) Int. Cl. H04Q 1/00; G05B 19/00

(52) U.S. Cl. 340/5.61; 340/10.1; 713/200

(57) ABSTRACT

### Abstract of Disclosure

An authentication system comprises an identification tag having an encrypted authorization code, a product having a corresponding encrypted code, an interrogator located remote to the identification tag, and a processor operatively connected to the interrogator and adapted under the control of software to include an authentication engine; the authentication engine providing access to the product upon verification of the encrypted authorization code.

### Cross Reference to Related Applications

This application claims priority from U.S. Provisional Applications Serial Nos. 60/192,034 and 60/192,061 which were both filed on March 24, 2000 and are incorporated by reference.

### Field of Invention

This invention relates to the field of authentication and identification, and more particularly to an identification tag, such as a radio frequency identification (RFID) tag that holds authentication and/or identification data which interfaces with a computer system to provide user authentication information.

### Background of Invention

In areas of commerce where the ease with which goods and currency drafts may be stolen or duplicated without authorization, the need exists for ways to deter such unauthorized uses.

Two types of transactions that are particularly susceptible to unauthorized exchanges occur in the area of software sales and public welfare disbursements.

Digital products, such as software and multimedia products are typically subject to unauthorized copying and installation. Authentication devices such as holographic images have been subject to unauthorized duplication. There is a need to provide a secure means for authenticating authorized users of software, multimedia and other digital products, which is not easily duplicated without authorization.

Government support payments, such as welfare disbursements, social security disbursements and food stamps are frequently stolen and/or fraudulently used and negotiated. Direct deposit of the disbursements has been used in some cases, but is often not practical with welfare and food stamp disbursements. There is a need to provide a system that securely authenticates an authorized recipient of a disbursement.

### Summary of Invention

In accordance with the present invention, an authentication system is provided which comprises an identification tag having an encrypted authentication code, a product having a corresponding encrypted code, and an interrogator located remote to the identification tag. The identification tag, in response to interrogation, communicates the encrypted authentication code. Such communicated data is utilized to authenticate an authorized user of a product.

The invention further includes a database of authorized users related to authentication codes and processor adapted to compare the communicated data with the database records.

In one embodiment of the present invention, the database may be located remotely. Access to the database is achieved via a communications link where the link may include a dial-up or computer network or wireless communication.

In another embodiment, the present invention is a digital product authentication system comprising: an identification tag having an encrypted authorization code; a digital product having a corresponding encrypted code; means for accessing the encrypted authorization code in the identification tag for authentication of the user of the digital product; wherein access is provided to the digital product upon authentication of the user.

In yet another embodiment, the present invention is a system for user authentication comprising: an identification tag having a first encrypted authorization code; a product having a second encrypted code; means for reading the encrypted authorization code in the identification tag for authentication of the user of the digital product; and an authentication means wherein the second encrypted code is determined to correspond to the first encrypted code.

The present invention includes a method for accessing a product, comprising the steps of: (i) providing an access authentication system comprising, an identification tag having an encrypted authorization code, the product having a corresponding encrypted code, and an interrogator located remote to the identification tag; (ii) sending a query signal from the interrogator to the identification tag; (iii) responding to the query signal by communicating the encrypted authorization code from the identification tag; (iv) authenticating the encrypted authorization code from the identification tag; and, (v) providing access to the product.

In another embodiment, the present invention is a method for payment disbursement. The method comprises the steps of: (i) providing an access authentication system comprising, an identification tag having an encrypted authorization code, the product having a corresponding encrypted code, and an interrogator located remote to the identification tag; (ii) sending a query signal from the interrogator to the identification tag; (iii) responding to the query signal by communicating the encrypted authorization code from the identification tag; (iv) authenticating the encrypted authorization code from the identification tag; and, (v) providing access to the product for payment disbursement.

Optionally, the methods of the present invention may include the step of sending a query signal from the interrogator to the product and responding to the query signal by communicating the encrypted code from the product.

### Brief Description of Drawings

A more complete understanding of the present invention may be obtained from consideration of the following description in conjunction with the drawings in which:

FIG. 1 is a functional overview of one embodiment of the present invention;

FIG. 2 is a detailed functional overview of an RFID tag which contains information such as an encrypted code and a licensed user count;

FIG. 3 is a functional overview of a second embodiment of the present invention;

FIG. 4 is a functional overview of a radio frequency identification system; and

FIG. 5 is a stylized overview of interconnected computer system networks.

### Detailed Description

Although the present invention is particularly well suited for authentication purposes, such as for verifying users of digital products such as software or recipients of checks, it should be understood that the present invention is also suited for use in controlling access to other digital products including, but not limited to, digital images, multimedia and the like and other disbursements, including but not limited to food stamps, and other documents.

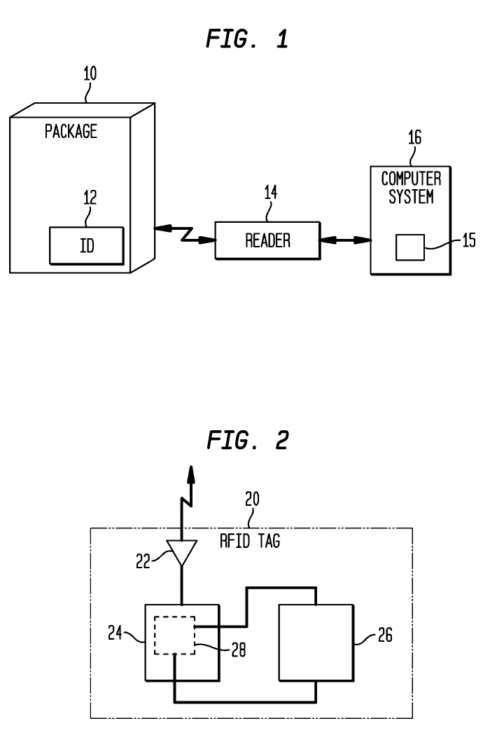

Referring to FIG. 1, a system employing the present invention comprises a package 10 containing an identification tag 12. The identification tag 12 may be an RFID or other suitable identification tag 12. The identification tag 12 contains encoded data corresponding to a unique product identification and an encrypted code contained in a medium used to distribute a digital product. The medium may be a CD-ROM, floppy disk, Digital Tape (including DAT), or a data file downloaded from a computer network such as the internet. A reader 14 interrogates the identification tag 12. The reader/interrogator 14 is coupled to a computer system 16, which has authentication engine or authentication program module 15. Optionally the interrogator 14 may be integral to the computer system 16 or to a personal digital assistant.

Referring to FIG. 2, an RFID tag 20 which contains an encrypted code and a user count, such as a licensed user count, is shown. RFID tag 20 comprises an antenna 22, a transponder 24 and an optional energy storage device 26. The RFID tag 20, in response to being interrogated, transmits an encrypted authorization code and encrypted licensed user count, stored in a memory 28, to the interrogator 14. An installation program for use of the digital product stored in package 10 utilizes the encrypted code and corresponding encrypted data in the medium used to distribute the digital product to authenticate an authorized user. A database is accessed by the installation program to compare the encrypted authorization code against database records. The database records may contain various pieces of information, such as user names, identification numbers, and licensed user counts. Optionally, the licensed user count is accessed and, if greater than zero, the installation is authenticated. Access to the digital product is then enabled. The licensed user count then may be decremented, encrypted and updated in the RFID tag 20. When the digital product is de-installed the installation is authenticated and if valid, the licensed user count is then incremented, encrypted and updated in the RFID tag 20.

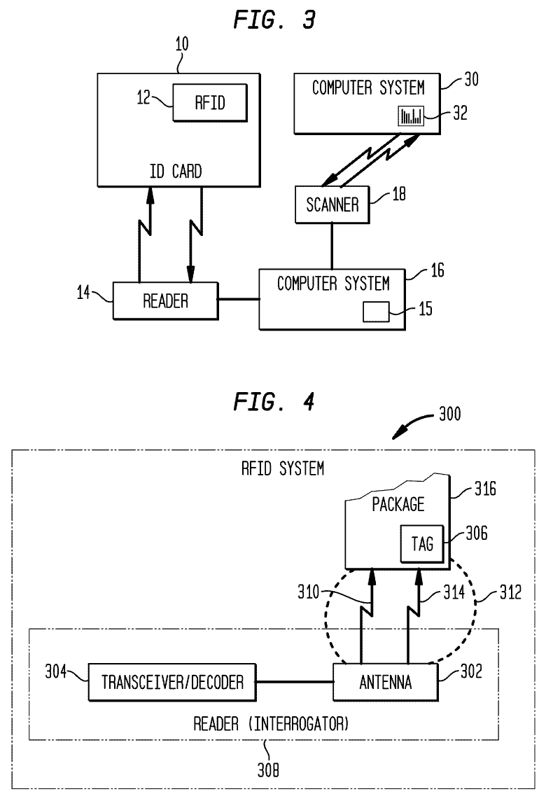

Referring to FIG. 3 the system of the present invention is employed in a payment disbursement application. An ID Card package 10 contains an identification tag 12. The identification tag 12 may be an RFID or other suitable identification tag 12. The identification tag 12 contains encoded data corresponding to an encrypted code. A reader 14 interrogates the identification tag 12. The reader (interrogator) 14 is coupled to a computer system 16, which has authentication engine or authentication program module 15. Optionally the interrogator 14 may be integral to the computer system 16 or a personal digital assistant. A scanner 18 reads an identifying code on a disbursement document 30, such as a bar code 32. The computer system 16 initiates the reader 14 to interrogate the identification tag 12. The identification tag 12 in response to being interrogated transmits the encrypted code. The computer initiates the scanner 18 to read the bar code 32 on the disbursement document 30. The authentication program module processes the encrypted code and corresponding bar code on the disbursement document to authenticate the recipient. Alternatively to a bar code 32, scannable characters and even manually entered codes can be utilized. For added security the disbursement document can have a second RFID attached, which would be interrogated to transmit its corresponding encrypted code. When the recipient is authenticated the disbursement is authorized. In other words, when the recipient is authenticated the check may be cashed, food stamps issued, food stamps used, or gift certificate redeemed.

Increasingly computer systems including personal digital assistants are being supplied that are wireless ready. An existing wireless interface or other suitable interface can be used to communicate with the identification tag 12, such as an RFID tag. Various encryption algorithms can be utilized.

The information provided by the system transaction can be communicated to a remote computer system over the Internet, thus enabling the disbursing authority to track the disbursement. The originating or monitoring authority for the disbursement can monitor the disbursement status and activity. This enables tracking activity in a database, which includes information such as check cashing habits. The remote computer system utilizes a software program to access the database to compare and verify the information provided, e.g. encrypted authorization code against database records. Access or completion of a transaction will be dependent upon the level of security in place. For example, the software program could allow the transaction, deny the transaction, or require additional information. By monitoring and tracking habits, a deviation from the norm can be used to trigger a requirement of additional identification. The deviation could be outside of an area (neighborhood), a new location. Analysis of the transaction and a subsequent request for additional identification can be initiated by an intelligent agent at the remote computer system or at the local computer system, thus providing another level of security.

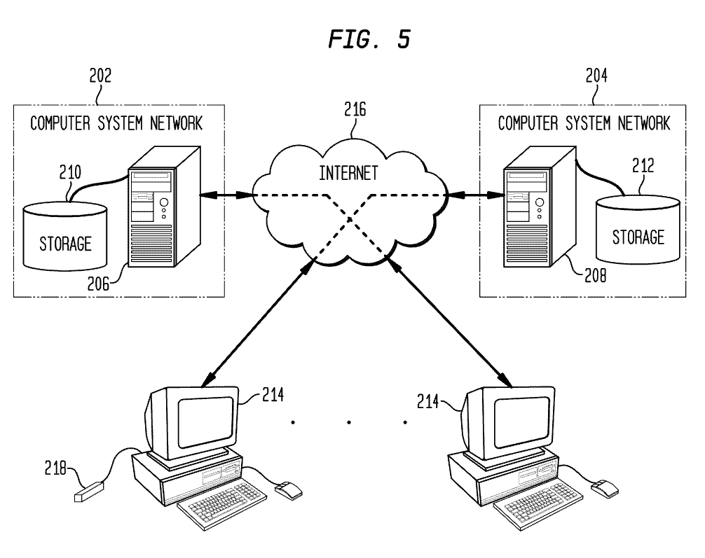

In FIG. 4, a Radio Frequency Identification (RFID) system is shown with antenna or coil 20; transceiver (with decoder) 14; and transponder (commonly called an RF tag) 20 programmed with unique information (data).

The antenna 20 emits radio signals to activate the tag 20 and read and write data to the tag 20. Antennas come in a variety of shapes and sizes. They can be built into a doorway to receive tag data from persons or things passing through the door. The electromagnetic field produced by an antenna 20 can be constantly present when multiple tags 20 are expected continually. If constant interrogation is not required, a sensor device can activate the field.

Often the antenna 20 is configured with the transceiver/decoder 14 to become a reader (interrogator) 308, which can be configured either as a handheld or a fixed-mount device. The reader 308 emits radio waves 310 in ranges of anywhere from one inch to 100 feet or more, depending upon its power output and the radio frequency used. When an RFID tag 20 passes through the electromagnetic zone 312, it detects the reader"s activation signal and responds by emitting radio waves 314. The reader 308 decodes the data encoded in the tag"s integrated circuit and the data is passed to a host computer for processing.

RFID tags 20 come in a wide variety of shapes and sizes. RFID tags 20 are categorized as either active or passive. Active RFID tags 20 are powered by an internal battery and are typically read/write, i.e., tag data can be rewritten and/or modified. An active tag"s memory size varies according to application requirements; some systems operate with up to 1MB of memory. In a typical read/write RFID system, a tag 20 can provide a set of instructions, and the tag 20 can receive information. This encoded data then becomes part of the history of the tagged product 10. The battery-supplied power of an active tag generally gives it a longer read range. The trade off is greater size, greater cost, and a limited operational life.

Passive RFID tags 20 operate without a separate external power source and obtain operation power generated from the reader 14. Passive tags 20 are consequently much lighter than active tags 20, less expensive, and offer a virtually unlimited operational lifetime. The trade off is that passive tags 20 have shorter read ranges than active tags and require a higher-powered reader.

Read-only tags 20 are typically passive and are programmed with a unique set of data (usually 32 to 128 bits) that cannot be modified. Read-only tags 20 most often operate as a key or index into a database, in the same way as linear barcodes reference a database containing modifiable product-specific information.

Frequency ranges also distinguish RFID systems. Low-frequency (30kHz to 500kHz) systems have short reading ranges and lower system costs. They are most commonly used in security access, asset tracking, and animal identification applications. High-frequency (850 mHz to 950 mHz and 2.4 gHz to 2.5 gHz) systems, offering long read ranges (greater than 90 feet) and high reading speeds.

The significant advantage of all types of RFID systems is the non-contact, non-line-of-sight nature of the technology. Tags 20 can be read through a variety of substances such as snow, fog, ice, paint, crusted grime, and other visually and environmentally challenging conditions, where barcodes or other optically read technologies would be useless. RFID tags 20 can also be read in challenging circumstances at remarkable speeds, in most cases responding in less than 100 milliseconds.

The range that can be achieved in an RFID system is essentially determined by: power available at the reader/interrogator 308 to communicate with the tag(s) 20; power available within the tag 20 to respond; and environmental conditions and structures, the former being more significant at higher frequencies including signal to noise ratio.

Although the level of available power is the primary determinant of range the manner and efficiency in which that power is deployed also influences the range. The field or wave delivered from an antenna extends into the space surrounding it and its strength diminishes with respect to distance. The antenna design will determine the shape of the field or propagation wave delivered, so that range will also be influenced by the angle subtended between the tag and antenna.

In space free of any obstructions or absorption mechanisms the strength of the field reduces in inverse proportion to the square of the distance. For a wave propagating through a region in which reflections can arise form the ground and from obstacles, the reduction in strength can vary quite considerable, in some case as an inverse fourth power of the distance. Where different paths arise in this way the phenomenon is known as multi-path attenuation. At higher frequencies absorption due to the presence of moisture can further influence range. It is therefore important in may applications to determine how the environment, internal or external, can influence the range of communication. Where a number of reflective metal "obstacles" are to encountered within the application to be considered, and can vary in number from time to time, it may also be necessary to establish the implications of such changes through an appropriate environmental evaluation.

The Internet is a worldwide system of computer networks - a network of networks in which users at one computer can obtain information from any other computer (and communicate with users of the other computers).

The Internet has evolved into a public, cooperative, and self-sustaining facility accessible to hundreds of millions of people worldwide. Physically, the Internet uses a portion of the total resources of the currently existing public telecommunication networks. Technically, what distinguishes the Internet is its use of a set of protocols called Transmission Control Protocol/Internet Protocol (TCP/IP).

The most widely used part of the Internet is the World Wide Web (often abbreviated "WWW" or called "the Web"). The most outstanding feature of the Web is its use of hypertext, a method of instant cross-referencing. In most Web sites, certain words or phrases appear in text of a different color than the rest; often this text is also underlined. When one of these words or phrases is selected, it"s a hyperlink, transferring the user to the site or page that is relevant to this word or phrase. Sometimes there are buttons, images, or portions of images that are "clickable." Using the Web provides access to millions of pages of information. Web "surfing" is done with a Web browser; the most popular of which are Netscape Navigator and Microsoft Internet Explorer. The appearance of a particular Web site may vary slightly depending on the particular browser used. Recent versions of browsers have plug ins, which provide animation, virtual reality, sound, and music.

Domain names direct where e-mail is sent, files are found, and computer resources are located. They are used when accessing information on the Web or connecting to other computers through Telenet. Internet users enter the domain name, which is automatically converted to the Internet Protocol address by the Domain Name System (DNS).

Referring to Fig. 5 there is shown a stylized overview of interconnected computer system networks. Each computer system network 202 and 204 contains a corresponding local computer processor unit 206, 208, which is coupled to a corresponding local data storage unit 210, 212. The local computer processor units 206 and 208 are selectively coupled to a plurality of users 214, which may have scanners, readers and other interface devices 218, through the Internet 216. A user 214 locates and selects (such as by clicking with a mouse) a particular Web page, the content of which is located on the local data storage unit 210 of the computer system network 202, to access the content of the Web page. The Web page may contain links to other computer systems and other Web pages.

Increasingly computer systems including personal digital assistants are being supplied that are wireless ready. An existing wireless interface or other suitable interface can be used to communicate with the RFID tag 20. Various encryption algorithms can be utilized, including those requiring that the media"s digital label, digital content and the RFID tag 20 be read.

The information provided by the RFID tag 20 can be communicated to a remote computer system over the Internet, thus enabling a shipper, manufacturer, security personnel or other concerned party to monitor and track licensing status.

In an alternative embodiment, the present invention is a digital product authentication system comprising: an identification tag having an encrypted authorization code; a digital product having a corresponding encrypted code; means for accessing the encrypted authorization code in the identification tag for authentication of the user of the digital product; wherein access is provided to the digital product upon authentication of the user.

In another alternative embodiment, the present invention is a system for user authentication comprising: an identification tag having a first encrypted authorization code; a product having a second encrypted code; means for reading the encrypted authorization code in the identification tag for authentication of the user of the digital product; and an authentication means wherein the second encrypted code is determined to correspond to the first encrypted code.

The present invention includes a method for accessing a product. The method comprising the steps of: (i) providing an access authentication system comprising, an identification tag having an encrypted authorization code, the product having a corresponding encrypted code, and an interrogator located remote to the identification tag; (ii) sending a query signal from the interrogator to the identification tag; (iii) responding to the query signal by communicating the encrypted authorization code from the identification tag; (iv) authenticating the encrypted authorization code from the identification tag; and, (v) providing access to the product.

Also included in the present invention is a method for payment disbursement. The method comprising the steps of: (i) providing an access authentication system comprising, an identification tag having an encrypted authorization code, the product having a corresponding encrypted code, and an interrogator located remote to the identification tag; (ii) sending a query signal from the interrogator to the identification tag; (iii) responding to the query signal by communicating the encrypted authorization code from the identification tag; (iv) authenticating the encrypted authorization code from the identification tag; and, (v) providing access to the product for payment disbursement.

Optionally, the methods of the present invention may include the step of sending a query signal from the interrogator to the product and responding to the query signal by communicating the encrypted code from the product.

In view of the foregoing description, numerous modifications and alternative embodiments of the invention will be apparent to those skilled in the art. The energy storage device may be charged by a variety of methods including external application of power, chemical generation, and electrostatic discharge. Accordingly, this description is to be construed as illustrative only and is for the purpose of teaching those skilled in the art the best mode of carrying out the invention. Details of the structure may be varied without departing from the invention.

Claims

1.An authentication system comprising:
an identification tag having an encrypted authorization code;
a product having a corresponding encrypted code;
an interrogator located remote to said identification tag; and
a processor operatively connected to said interrogator and adapted under the control of software to include an authentication engine;
said authentication engine providing access to said product upon verification of said encrypted authorization code.

2.The system of claim 1, further comprising a database having records of authorized users related to said encrypted authorization code or said encrypted code.

3.The system of claim 2, wherein said authentication engine accesses said database to obtain verification of said encryption authorization code or said encryption code.

4.The system of claim 1, wherein said identification tag is a radio frequency identification transponder.

5.The system of claim 1, wherein at least one of said identification tag and said product further comprises a user count.

6.The system of claim 1, further comprising a computer or personal digital assistant.

7.A method for accessing a product, comprising the steps of:
(i) providing an access authentication system comprising,
an identification tag having an encrypted authorization code;
said product having a corresponding encrypted code;
an interrogator located remote to said identification tag; and
a processor operatively connected to said interrogator and adapted under the control of software to include an authentication engine;
said authentication engine providing access to said product upon verification of said encrypted authorization code;
(ii) sending a query signal from said interrogator to said identification tag;
(iii) responding to said query signal by communicating said encrypted authorization code from said identification tag to said processor;
(iv) authenticating said encrypted authorization code from said identification tag; and,
(v) providing access to said product.

8.The method of claim 7, wherein said access authentication system further comprises a database having records of authorized users related to said encrypted authorization code or said encrypted code.

9.The method of claim 8, wherein said authentication engine accesses said database to obtain verification of said encryption authorization code or said encryption code.

10.The method of claim 7, wherein said identification tag is a radio frequency identification transponder.

11.The method of claim 7, wherein at least one of said identification tag and said product further comprises a user count.

12.The method of claim 7, further comprising the step of sending a query signal from said interrogator to said product and responding to said query signal by communicating said encrypted code from said product.

13.The method of claim 7, wherein said product is a digital product.

14.The method of claim 7, wherein said access authentication system further comprises a computer or personal digital assistant.

15.A method for payment disbursement, comprising the steps of:
(i) providing an access authentication system comprising,
an identification tag having an encrypted authorization code;
a product having a corresponding encrypted code;
an interrogator located remote to said identification tag; and
a processor operatively connected to said interrogator and adapted under the control of software to include an authentication engine;
said authentication engine providing access to said product upon verification of said encrypted authorization code;
(ii) sending a query signal from said interrogator to said identification tag;
(iii) responding to said query signal by communicating said encrypted authorization code from said identification tag;
(iv) authenticating said encrypted authorization code from said identification tag; and,
(v) providing access to said product for payment disbursement.

16.The method of claim 15, wherein said access authentication system further comprises a database having records of authorized users related to said encrypted authorization code or said encrypted code.

17.The method of claim 16, wherein said authentication engine accesses said database to obtain verification of said encryption authorization code or said encryption code.

18.The method of claim 15, wherein said identification tag is a radio frequency identification transponder.

19.The method of claim 15, further comprising the step of sending a query signal from said interrogator to said product and responding to said query signal by communicating said encrypted code from said product.

20.The method of claim 15, wherein said access authentication system further comprises a computer.

21.A digital product authentication system comprising:
an identification tag having an encrypted authorization code;
a digital product having a corresponding encrypted code;
means for accessing said encrypted authorization code in said identification tag for authentication of a user of said digital product;
wherein access is provided to said digital product upon authentication of the user.

22.The system of claim 21, further comprising a database having records of authorized users related to said encrypted authorization code or said encrypted code.

23.The system of claim 22, wherein said authentication engine accesses said database to obtain verification of said encryption authorization code or said encryption code.

24.The system of claim 21, wherein said identification tag is a radio frequency identification transponder.

25.A system for user authentication comprising:
an identification tag having a first encrypted authorization code;
a product having a second encrypted code;
means for reading said encrypted authorization code in said identification tag for authentication of a user of said digital product; and
an authentication means wherein said second encrypted code is determined to correspond to said first encrypted code.

26.The system of claim 25, further comprising a database having records of authorized users related to said encrypted authorization code or said encrypted code.

27.The system of claim 26, wherein said authentication engine accesses said database to obtain verification of said encryption authorization code or said encryption code.

28.The system of claim 25, wherein said identification tag is a radio frequency identification transponder.

29.An authentication system comprising:
a radio frequency identification tag having an encrypted authorization code;
a product having a corresponding encrypted code;
an interrogator located remote to said radio frequency identification tag; and,
a processor operatively connected to said interrogator and adapted under the control of software to include an authentication engine;
said authentication engine providing access to said product upon verification of said encrypted authorization code.
